(19) United States
(12) Patent Application Publication
(10) Pub. No.: US 2018/0349835 A1
(43) Pub. Date: Dec. 6, 2018

(54) SERVER AND SYSTEM

(71) Applicant: SEIKO EPSON CORPORATION, Tokyo (JP)

(72) Inventor: Go Ishida, Nagano (JP)

(21) Appl. No.: 15/954,823

(22) Filed: Apr. 17, 2018

(30) Foreign Application Priority Data
May 30, 2017 (JP) 2017-106402

(51) Int. Cl. G06Q 10/08

(52) U.S. Cl. CPC G06Q 10/087

(57) ABSTRACT

A server includes: a communication unit that performs communication via a network; a storage unit that stores association information in which identification information on a device that utilizes consumables is associated with purchase source information indicating a purchase source from which the consumables are to be purchased; and a control unit that, when the communication unit receives identification information, causes the communication unit to transmit window information used for purchasing the consumables from a purchase source indicated by the purchase source information associated with the received identification information in accordance with the association information.

### BACKGROUND

### 1. Technical Field

The present invention relates to a server and a system that support purchase of consumables used in a device.

### 2. Related Art

A user of a printer needs to timely replace consumables such as ink. In order to support such a user, application software that monitors the remaining ink level of a printer and prompts the user to purchase ink when the remaining ink level decreases is known.

The related art discloses a system for purchasing consumables of a printer apparatus. The system has a control unit that displays a status window indicating the consumption degree of consumables used in a printer apparatus and displays, in the status window, a delivery and purchase button used to request purchase and delivery of the consumables (see JP-A-2002-123384).

In the art described above, however, it is difficult for the user to purchase consumables from a suitable (particular) sales channel out of many existing sales channels that sell such consumables.

### SUMMARY

An advantage of the invention is to provide a server and a system that support purchase of consumables in an appropriate manner.

A server according to an aspect of the invention includes a communication unit that performs communication via a network; a storage unit that stores association information in which identification information on a device that utilizes consumables is associated with purchase source information indicating a purchase source from which the consumables are to be purchased; and a control unit that, when the communication unit receives identification information, causes the communication unit to transmit window information used for purchasing the consumables from a purchase source indicated by the purchase source information associated with the received identification information in accordance with the association information.

According to the above configuration, the server externally transmits the window information used for purchasing consumables from a purchase source in association with the identification information of the device externally received. It is therefore possible to support the user of the device to purchase consumables from the purchase source which is suitable to purchase the consumables (suitable sales channel) in a more appropriate manner.

It is preferable that the communication unit receive the identification information and consumables information that indicates a consumption degree of the consumables, and the control unit generate the window information when the consumption degree is determined to exceed a predetermined reference in accordance with the consumables information.

According to the above configuration, the server can generate and externally transmit the window information at a suitable timing, that is, in a situation where the consumption degree of the consumables in the device is relatively high.

It is preferable that, when the communication unit receives an order instruction of the consumables in accordance with the transmitted window information, the control unit cause the communication unit to transmit a delivery request of the consumables to the purchase source associated with the window information.

According to the above configuration, it is possible to transmit the delivery request of the consumables to the purchase source which is suitable to purchase the consumables (suitable sales channel) in response to the order instruction in accordance with the window information.

It is preferable that the purchase source information stored in the storage unit in association with identification information of the device indicate a purchase source of the device.

According to the above configuration, it is possible to support purchase of the consumables from the purchase source from which the user has purchased the device (suitable sales channel) in a more appropriate manner by using the window information.

It is preferable that the control unit generate price window information to display a price of the consumables designated on a consumables purchase window that is displayed by the window information and cause the communication unit to transmit the price window information.

According to the above configuration, it is possible to indicate the price of the consumables designated by the consumables purchase window and support purchase of consumables in a more appropriate manner.

The technical concept of the invention may be implemented in various forms other than the category of a server.

For example, a system according to another aspect of the invention includes a communication device and a server that perform communication via a network. The server stores association information that associates identification information of a device that utilizes consumables with purchase source information that indicates the purchase source from which the consumables are to be purchased and, when receiving identification information from the communication device, transmits window information used for purchasing the consumables from a purchase source indicated by the purchase source information associated with the received identification information to the communication device in accordance with the association information, and the communication device causes a display unit to display consumables purchase window to purchase the consumables in accordance with the transmitted window information.

Further, the invention may include a method corresponding to each process performed by the server or the system described above, a program that causes a computer (a server or a communication device) to perform the method, or a computer readable storage medium storing the program therein.

### BRIEF DESCRIPTION OF THE DRAWINGS

The invention will be described with reference to the accompanying drawings, wherein like numbers reference like elements.

FIG. 1 is a diagram schematically illustrating a system according to an embodiment.

FIG. 2 is a diagram illustrating a relationship among a shop-side terminal, a sales management server, and a consumables management server.

FIG. 3 is a diagram illustrating a relationship or the like of a user terminal and the consumables management server.

FIG. 4 is a flowchart illustrating a registration confirmation process.

FIG. 5 is a diagram illustrating a relationship or the like of the user terminal and the consumables management server.

FIG. 6 is a diagram illustrating a relationship among the consumables management server, the sales management server, and the delivery-side terminal.

FIG. 7 is a flowchart illustrating a consumable order process.

FIG. 8 is a diagram illustrating an example of a consumables purchase window.

FIG. 9 is a diagram schematically illustrating a system according to a second embodiment.

### DESCRIPTION OF EXEMPLARY EMBODIMENTS

Embodiments of the invention will be described below with reference to the drawings. Note that each drawing is a mere example for illustrating the embodiment.

### 1. System

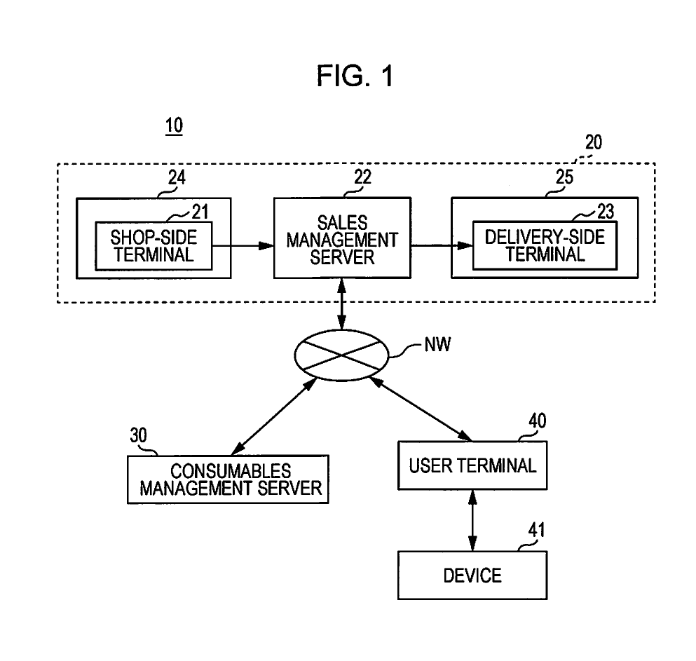

FIG. 1 schematically illustrates a system 10 according to the present embodiment. The system 10 includes, for example, a sales management server 22, a consumables management server 30, a user terminal 40, and a device 41. Each of the sales management server 22, the consumables management server 30, and the user terminal 40 is connected to a network NW. An example of the network NW is the Internet. Further, the network NW may be a Local Area Network (LAN) and the like connected to the Internet. Note that the network NW may be a wired network or a wireless network.

At least some of the components of the system 10 are collectively referred to as a consumables management system. The consumables management server 30 is a specific example of the server of the invention. Note that expressions such as “consumable management system” and “consumables management server” are mere names of the system, and the server and may be referred to as, for example, a consumables purchase support system, a consumables purchase support server, a window information generating system, a window information generating server, or the like.

The user terminal 40 is implemented by, for example, a personal computer (PC), a smartphone, a tablet terminal, a mobile phone, or terminals having a function similar thereto. The user terminal 40 can display a consumables purchase window 50 as described below to accept operations to the consumables purchase window 50. The user terminal 40 is a specific example of the communication device according to the invention. The device 41 is a device utilizing consumables. The device 41 corresponds to various products utilizing consumables, such as a printer, a compound machine, a projector, or the like. Description will be continued below with an example in which the device 41 may be a printer and a consumable may be an ink cartridge used in the printer (the device 41).

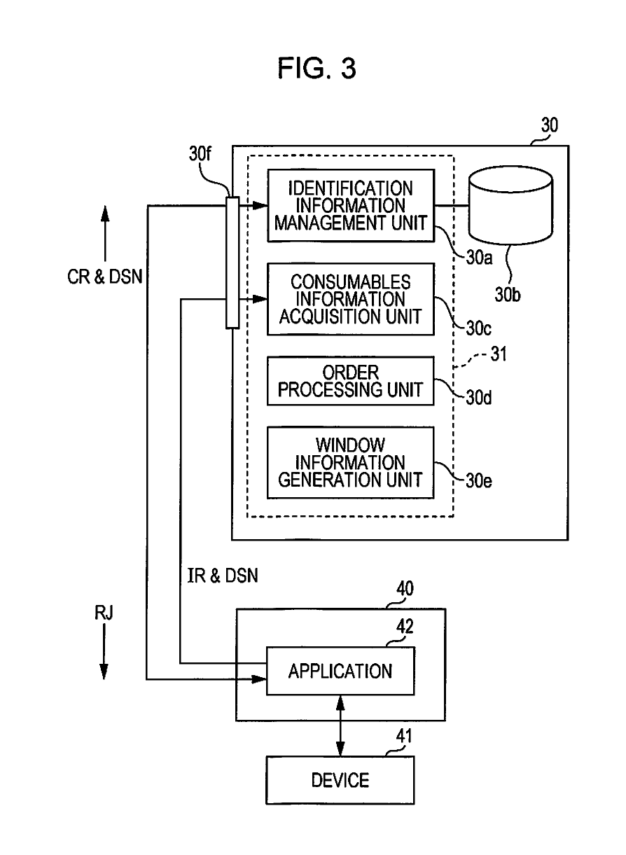

The user terminal 40 is communicably connected to the device 41 via a wired connection or a wireless connection and controls the operation of the device 41. A driver (printer driver) used for controlling the device 41 or an application 42 used for causing the user terminal 40 to implement specific functions such as monitoring of the device 41 (see FIG. 3 or the like) is preinstalled in the user terminal 40.

The sales management server 22 belongs to a certain sales channel 20. The sales channel 20 represents an entity (or a group of entities) that sells the device 41 or consumables thereof. For example, the sales channel 20 may be electronics retail shops and distribution groups. The entity of the sales channel 20 may be a single company or an organization or may be a set of multiple companies or organizations having a profit-sharing-relationship. While FIG. 1 illustrates a single sales channel 20, there may be a plurality of sales channels 20. Further, in the example of FIG. 1, the single sales channel 20 includes a shop-side terminal 21 and a delivery-side terminal 23 in addition to the sales management server 22.

For example, the shop-side terminal 21 is a terminal installed in a shop 24 that sells the device 41 and is connected to the sales management server 22 of the sales channel 20. For example, the delivery-side terminal 23 is a terminal installed in a delivery center 25 that holds consumables in stock and delivers the consumables to the outside as required and is connected to the sales management server 22 in the sales channel 20.

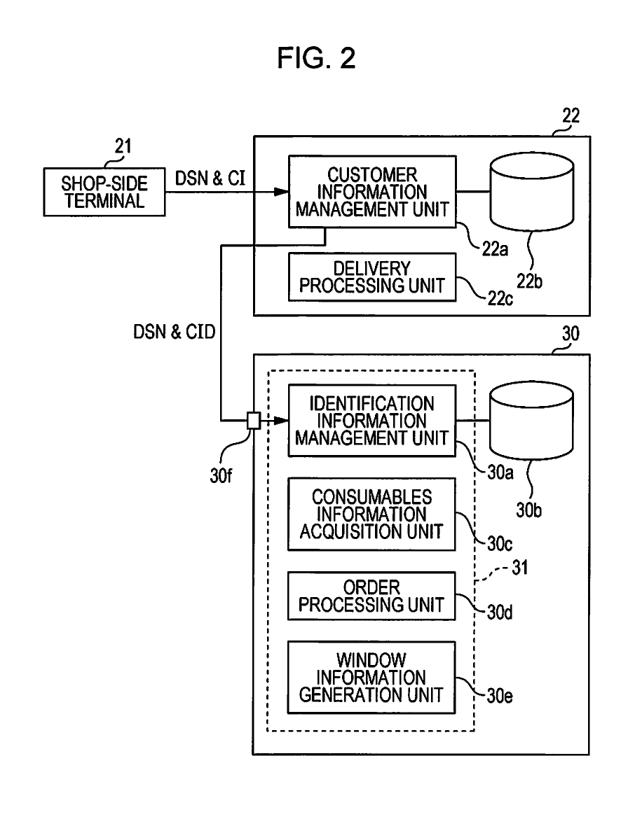

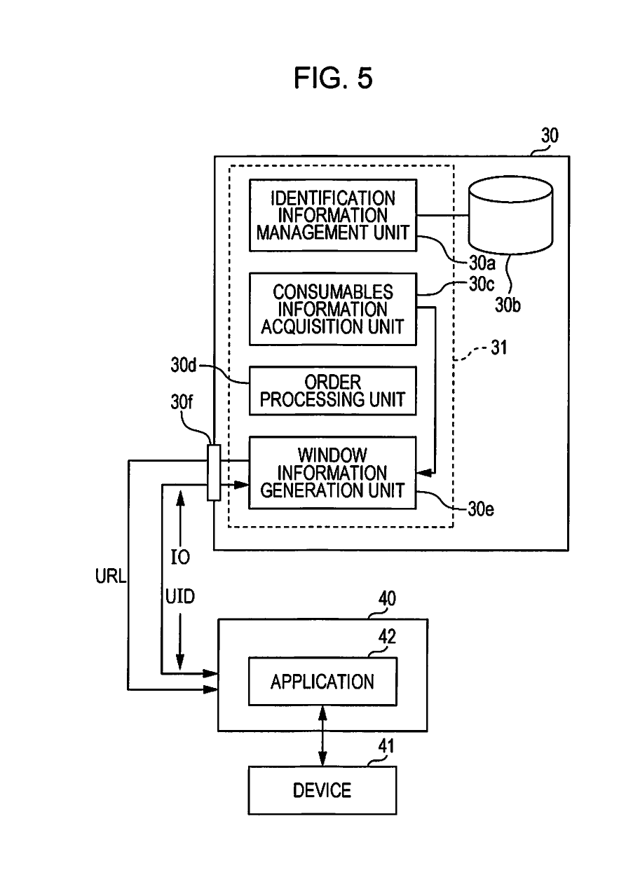

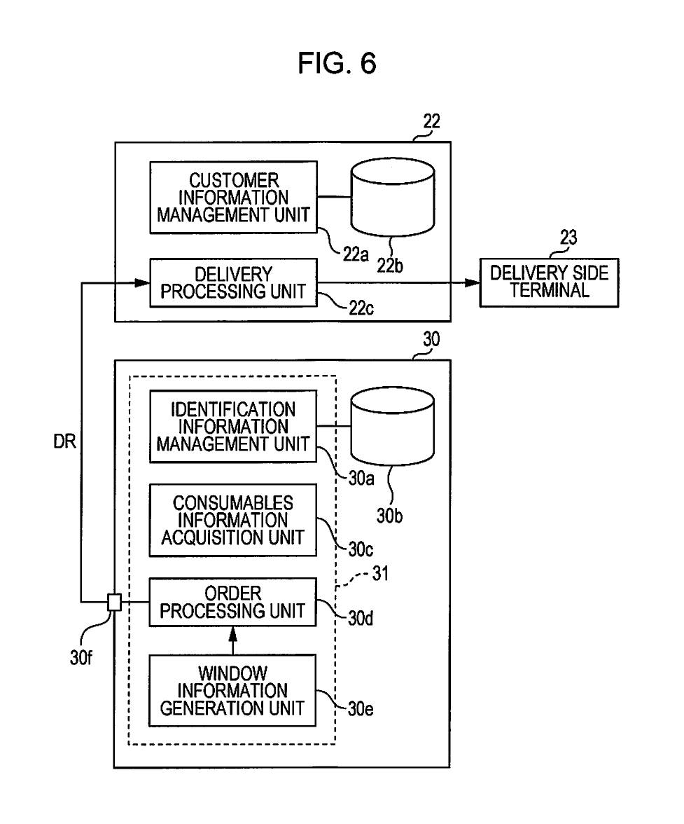

Although described in detail later, the consumables management server 30 includes a communication interface 30f that enables communication with the outside via the network NW, an identification information management unit 30a that associates identification information of the device 41 that utilizes consumables with purchase source information that indicates a purchase source from which the consumables are to be purchased and manages the associated information as association information, and an order processing unit 30d that transmits a request for delivery of the consumables (hereinafter referred to as a delivery request) to the purchase source via the network NW in accordance with purchase source information associated with identification information of the device 41. Further, the consumables management server 30 has a window information generation unit 30e, a consumables information acquisition unit 30c, and the like that, upon receiving identification information of the device 41, generate window information used for purchasing consumables from the purchase source indicated by purchase source information associated with identification information and performs a process of transmitting the window information (see FIG. 2, FIG. 3, FIG. 5, and FIG. 6).

The identification information management unit 30a, the consumables information acquisition unit 30c, the order processing unit 30d, and the window information generation unit 30e may be collectively referred to as a control unit 31 of the consumables management server 30. Further, the “control unit 31 and the communication interface 30f” cooperate with each other in a configuration necessary for implementing communication with the outside via the network NW and may be collectively referred to as a communication unit of the consumables management server 30.

The expression “purchase source from which the consumables are to be purchased” associated with the device 41 (identification information of the device 41) means the sales channel 20 to which the shop 24 from which the user has purchased the device 41 belongs (the sales channel 20 that has sold the device 41 to the user). When viewed from the consumables management server 30, the sales management server 22 to be communicated with via the network NW forms a part of the sales channel 20.

The servers 22 and 30 are servers that provide services to each user via the Internet. For example, the servers 22 and 30 are implemented as a part of a cloud environment (a virtual server) that provides cloud services. Each of the servers 22 and 30 may be referred to as a cloud server. Alternatively, each of the servers 22 and 30 may be a physical server. Each part of the sales management server 22 (see 22a, 22c, FIG. 2, and FIG. 6) is implemented by hardware and software of the sales management server 22 in cooperation with each other, for example. Similarly, each part of the consumables management server 30 (see 30a, 30c, 30d, 30e, 30f, FIG. 2, FIG. 3, FIG. 5, and FIG. 6), is implemented by hardware and software of the consumables management server 30 in cooperation with each other, for example. That is, in the consumables management server 30, the process of the control unit 31 of the consumables management server 30 is executed by a processor (including a processing circuit such as a CPU or an Application Specific Integrated Circuit (ASIC)).

For example, the sales management server 22 may, as one of the functions thereof, provide an Internet user with a shopping site (a virtual shop) on the Internet operated by the related sales channel 20. The shop 24 may be a real shop or such a virtual shop.

Obviously, each of the sales management server 22 and the user terminal 40 has a communication interface to communicate with the outside via the network NW in a similar manner to the consumables management server 30. The communication interface communicates in accordance with a predetermined communication standard (for example, TCP/IP, HTTP, or the like). In the presented embodiment, the standard of the communication via the network NW among the sales management server 22, the consumables management server 30, and the user terminal 40, communication within the sales channel 20, or communication between the user terminal 40 and the device 41 is not particularly limited.

In particular, a service provided to the user of the device 41 in cooperation with the servers 22 and 30 (the present service) may be referred to as, for example, a consumables delivery service, a consumables purchase support service, or the like. The mechanism of the present service will be described below.

### 2. Registration Process Triggered by Purchase of Device

FIG. 2 is a diagram illustrating the relationships between the shop-side terminal 21, the sales management server 22, and the consumables management server 30. Suppose that a user purchases a device 41 at a shop 24 belonging to a certain sales channel 20. The shop 24 accepts an application for the use of the present service from the user who purchased the device 41. When the user applies to use the present service, both the identification information of the device 41 purchased by the user and the personal information of the user (customer information CI) are transmitted from the shop-side terminal 21 to the sales management server 22. In this example, the identification information of the device 41 is unique information provided in advance to each device 41 and indicates the serial number of each device 41 (serial number DSN). Customer information CI may include, for example, a user name, an address (delivery destination information), a contact address, a credit card number, and the like.

For example, the shop-side terminal 21 and the sales management server 22 may also serve as a component of a so-called point of sale (POS) system constructed in the sales channel 20. In this case, the serial number DSN of the device 41 input via the shop-side terminal 21 and customer information CI are stored in the sales management server 22 via a POS system. Further, when the shop 24 is a shopping site on the Internet (virtual shop), the site performs substantially the same function as that of the shop-side terminal 21, and both the serial number DSN of the device 41 which has been determined to be purchased at the site by the user who accessed the site and the customer information CI input by the user to the site are transmitted to the sales management server 22 via the site.

The sales management server 22 has a customer information management unit 22a as one of the functions that manages identification information (the serial number DSN) of the purchased device 41 and customer information CI in association with (linked with) each other. The customer information management unit 22a receives the serial number DSN and customer information CI transmitted from the shop-side terminal 21 and stores the received serial number DSN and the received customer information CI in a predetermined storage unit 22b in association with each other as described above. As a result, in response to the purchase of the device 41 by the user, the serial number DSN of the device 41 and customer information CI of the user who purchased the device 41 are registered in the sales management server 22. For example, a storage unit 22b is formed of a storage device such as a hard disk drive or a flash memory. As described above, customer information CI includes any address designated by the user. Such an address is delivery destination information indicating the delivery destination used by the sales channel 20 to deliver the consumables to the user who uses the present service.

The sales management server 22 (the customer information management unit 22a) transmits the serial number DSN of the device 41 received as described above to the consumables management server 30 via the network NW. At this time, the sales management server 22 transmits unique identification information (channel identification information CID) for identifying itself (the sales channel 20 to which the server 22 belongs) together with the serial number DSN of the device 41 to the consumables management server 30. Channel identification information CID is predetermined identification information unique to each sales channel 20. Such channel identification information CID corresponds to purchase source information.

In the consumables management server 30, the identification management unit 30a receives the serial number DSN and the channel identification information CID transmitted from the sales management server 22 via the communication interface 30f and stores the received serial number DSN and the received channel identification information CID in association with each other in a predetermined storage unit 30b. As a result, in response to the purchase of the device 41 by the user, the serial number DSN of the device 41 and purchase source information (channel identification information CID) indicating the purchase source of the device 41 are registered in the consumables management server 30. For example, the storage unit 30b is formed of a storage device such as a hard disk drive or a flash memory. In terms of the protection of private information, the sales management server 22 does not transmit customer information CI to the consumables management server 30.

### 3. Process of Device Monitoring and Consumables Information Transmission

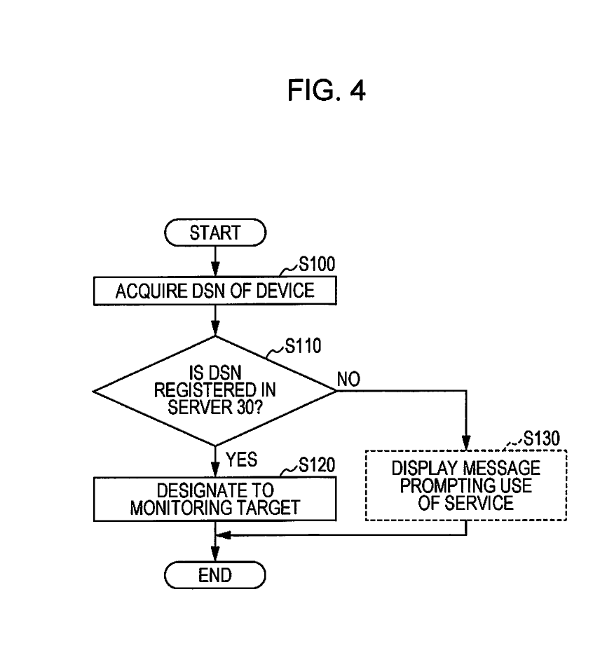

FIG. 3 is a diagram illustrating the relationship between the user terminal 40 and the consumables management server 30. FIG. 4 is a flowchart illustrating a registration confirmation process performed by the user terminal 40 as a prerequisite for monitoring the device 41. The registration confirmation process is one of the processes that the application 42 causes the user terminal 40 to perform. In step S100, the application 42 (the user terminal 40 installed with the application 42, the same hereinafter) acquires the serial number DSN of the device 41. For example, the application 42 transmits an acquisition request of the serial number DSN to the device 41 connected to the user terminal 40. The device 41 that has received the acquisition request transmits the serial number DSN thereof to the user terminal 40. The application 42 receives and acquires the serial number DSN transmitted by the device 41 as a response to the acquisition request described above.

In step S110, the application 42 determines whether or not the serial number DSN of the device 41 acquired in step S100 is registered in the consumables management server 30. That is, it is determined whether or not the device 41 having the serial number DSN is in a state where the service can be used. For example, the application 42 transmits the serial number DSN acquired in step S100 together with the registration confirmation request (registration confirmation request CR) for the serial number DSN to the consumables management server 30 via the network NW. In the consumables management server 30 that has received the registration confirmation request CR, the identification information management unit 30a determines whether or not the serial number DSN received with the registration confirmation request CR is stored (registered) in the storage unit 30d and transmits the determination result (determination result RJ) via the network NW to the user terminal 40 that is the sender of the registration confirmation request CR. The application 42 branches the process in accordance with the determination result RJ transmitted from the consumables management server 30 as a response to the registration confirmation request CR.

That is, if the determination result RJ indicates that the serial number DSN transmitted together with the registration confirmation request CR is stored in the storage unit 30b, the application 42 determines that the serial number DSN acquired in step S100 is registered in the consumables management server 30 (step S110, “Yes”) and proceeds to step S120. In step S120, the application 42 designates the device 41 that has acquired the serial number DSN in step S100 as a monitoring target and ends the process shown in the flowchart. On the other hand, if the determination result RJ indicates that the serial number DSN transmitted together with the registration confirmation request CR is not stored in the storage unit 30b, the application 42 determines that the serial number DSN acquired in step S100 is not registered in the consumables management server 30 (step S110, “No”).

If “No” is determined in step S110, the application 42 does not designate the device 41 that has acquired the serial number DSN in step S100 as a monitoring target and ends process shown in the flowchart. Note that, if “No” is determined in step S110, the application 42 can cause a message prompting application of the present service to be displayed on the screen of the user terminal 40 in the form of a popup window or the like (step S130).

The application 42 monitors the device 41 designated as the monitoring target and acquires the consumables information (consumables information IR) on the consumables from the device 41. When the consumable is an ink cartridge as described above, the application 42 acquires from the device 41 the remaining ink level of each ink cartridge mounted in the device 41. The remaining ink level is information that directly or indirectly indicates, or provide an estimation of the amount of ink remaining in the ink cartridge. The remaining ink level can be information indicating a consumption degree of the consumables. A printer (device 41) has a plurality of cartridges for each color (for example, black, cyan, magenta, and yellow). Although detailed illustration is omitted, each ink cartridge has an IC chip, and the current remaining ink level in the ink cartridge is recorded in the IC chip, for example. Thus, the application 42 can acquire the current remaining ink level for each color recorded in the IC chip of each ink cartridge as one of the pieces of consumables information IR.

The application 42 transmits the most recent consumables information IR of the device 41 designated as the monitoring target to the consumables management server 30 periodically or sporadically. For example, the application 42 transmits consumables information IR of the device 41 to the consumables management server 30 once a day at a predetermined time. The frequency at which the application 42 acquires consumables information IR from the device 41 varies. For example, the application 42 may acquire consumables information IR every time the device 41 finishes printing in accordance with a print job or, when the timing to transmit consumables information IR to the consumables management server 30 is determined in advance, the application 42 may acquire the consumables information IR before the timing.

When transmitting consumables information IR of the device 41 to the consumables management server 30, the application 42 also transmits the serial number DSN of the device 41 related to the acquisition of the consumables information IR. Further, the application 42 may include a serial number of each ink cartridge (the cartridge serial number), model number information of each ink cartridge, or the like in addition to the remaining ink level of each ink cartridge acquired from the device 41 in the consumables information IR that is transmitted to the consumables management server 30. A unique serial number is also provided to the ink cartridge for each individual.

In the consumables management server 30, the consumables information acquisition unit 30c receives and acquires consumables information IR and the serial number DSN of the device 41 transmitted from the application 42 via the communication interface 30f. Although only a single combination of the device 41 and the user terminal 40 is described in FIG. 1, FIG. 3, and the like, there are many such combinations in accordance with the number of the devices 41 using the present service. Therefore, the consumables information acquisition unit 30c can acquire consumables information IR for each device 41 identified by identification information (the serial number DSN) via the network NW.

### 4. Process of Generation of Window Information and Order of Window Information-Based Consumables

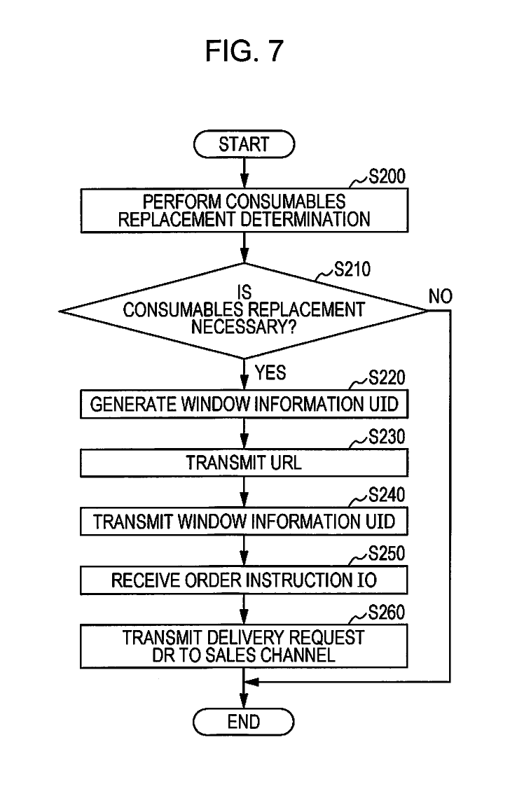

FIG. 5 is a diagram illustrating the relationship between the user terminal 40 and the consumables management server 30 or the like. FIG. 6 is a diagram illustrating the relationship among the consumables management server 30, the sales management server 22, and the delivery-side terminal 23. FIG. 7 is a flowchart illustrating a process of ordering consumables performed by the control unit 31 (mainly, the window information generation unit 30e and the order processing unit 30d).

When receiving consumables information IR and the serial number DSN of the device 41 from the user terminal 40 as described above, the consumables information acquisition unit 30c informs the window information generation unit 30e of a notification of the reception. For simplified illustration below, the user terminal 40 that is the source of consumables information IR and the serial number DSN received by the consumables information acquisition unit 30c is referred to as the target user terminal 40. The window information generation unit 30e that is informed of the notification of the reception generates window information UID used for purchasing the consumables form the sales channel that is indicated by the channel identifying information CID stored in the storage unit 30b in the association with the serial number DSN received above (step S220 in FIG. 7).

The window information generation unit 30e may generate window information UID in response to the notification of the reception, or when receiving the notification of the reception, may perform the determination as to whether or not the consumables are to be replaced in accordance with the consumables information IR received by the consumables information unit 30c together with the serial number DSN (consumables replacement determination) and branch whether or not to generate window information UID in accordance with the determination result. FIG. 7 illustrates a flowchart when branching whether or not to generate window information UID in accordance with the consumables replacement determination.

FIG. 7 is described with reference to FIG. 5 and FIG. 6. The window information generation unit 30e that has received the notification of the reception of consumables information IR and the serial number DSN of the device 41 from the consumables information acquisition unit 30c performs the consumables replacement determination in accordance with the received consumables information IR (step S200). Basically, the window information generation unit 30e compares the remaining ink level of each ink cartridge included in the consumables information IR with the predetermined threshold and determines the ink cartridge whose remaining ink level is below the threshold (the degree of consumption exceeds the predetermined reference) as the consumables to be replaced. When there are one or more consumables to be replaced for a single device 41, the window information generation unit 30e determines that replacement of the consumables is necessary (step S210, “Yes”). The window information generation unit 30e proceeds to step S220 if “Yes” is determined in step S210 or ends the process shown in the flowchart of FIG. 7 if “No” is determined in step S210.

Note that the window information generation unit 30e performs the step S220 and subsequent steps without performing steps S200 and S210 in FIG. 7 when generating window information UID in response to receiving the notification of the reception of the consumables information IR and the serial number DSN of the device 41 from the consumables information acquisition unit 30c.

In step S220, the window information generation unit 30e acquires channel identification information CID associated with the received serial number DSN from the identification information management unit 30a (the storage unit 30b). Window information UID is then generated to display the consumables purchase window 50 dedicated for the sales channel indicated by the acquired channel identification information CID. The consumables purchase window 50 is a type of web pages. Therefore, the consumables purchase window 50 is information described in a format for displaying web pages, for example, Hyper Text Markup Language (HTML).

Next, the window information generation unit 30e transmits the Uniform Resource Locator (URL) of the window information UID generated in step S220 to the target user terminal 40 via the communication interface 30f (step S230). URL is information used for accessing the window information UID and indicates such as a storage location of window information UID in the network NW (the storage location of UID in the consumables management server 30).

On the target user terminal 40 side, access to the web page is performed in accordance with the URL using a function of an installed common browser when the URL is received from the consumables management server 30. Therefore, in response to the access request in accordance with the URL by the target user terminal 40, the consumables management server 30 (the window information generation unit 30e) transmits window information UID generated in step S220 to the target user terminal 40 via communication interface 30f (step S240). On the target user terminal 40 side that has received the window information UID from the consumables management server 30, the browser causes the predetermined display unit (a liquid crystal display device and the like) to display the consumables purchase window 50 based on the window information UID.

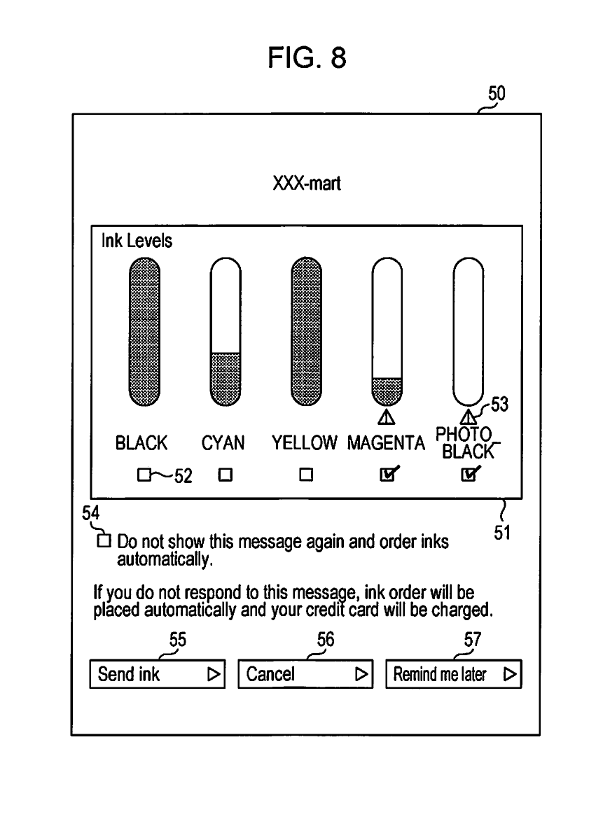

FIG. 8 illustrates an example of the consumables purchase window 50. The consumables purchase window 50 is a dedicated screen for the sales channel 20 associated in the storage unit 30b with the serial number DSN that the consumables management server 30 has received together with consumables information IR of the device 41 from the target user terminal 40. FIG. 8 illustrates the consumables purchase window 50 dedicated for the sales channel 20 with a trade name “XXX-mart” as an example. The consumables purchase window 50 has a remaining ink level display field 51.

On the remaining ink level display field 51, the remaining ink level of each ink cartridge included in the consumables information IR that the consumables management server 30 has received from the target user terminal 40 is displayed in a visually understandable form. Further, the remaining ink level display field 51 has a check box 52 for each ink cartridge of each color, and the user operating the target user terminal 40 may check the check box 52 corresponding to the intended ink cartridge. Further, the remaining ink level display field 51 displays an icon 53 used for a warning with respect to an ink cartridge of a color whose remaining ink level is below the threshold (the degree of consumption exceeds the predetermined reference) and prompts the user to purchase the ink cartridge. Note that, even when the steps S200 and S210 in the flowchart in FIG. 7 are not executed, the window information generation unit 30e may compare the remaining ink level of each ink cartridge with the threshold to determine the design of the remaining ink level display field 51 when generating window information UID (step S220).

The consumables purchase window 50 further includes a check box 54, an order button 55, a cancellation button 56, a reminder notice button 57, or the like. The check box 54 is a field to be checked by a user who does not want to display the consumables purchase window 50 (does not want to order consumables by operation on the consumables purchase window 50). If the check box 54 is checked by the target user terminal 40, the consumables management server 30 then performs a “automatic consumables order process” instead of processing steps S220 to S250 for the target user terminal 40. The automatic consumables order process will be described below.

The order button 55 is a button used for confirming an order of the ink cartridge currently checked at check box 52. The cancellation button 56 is a button used for discarding the current check status for the check box 52 and closing the consumables purchase window 50. The reminder notice button 57 is a button used for selecting to temporarily close the consumables purchase window 50 and again display the consumables purchase window 50 later. When the order button 55 is operated on the consumables purchase window 50, the target user terminal 40 transmits an order instruction IO of the ink cartridge checked at the check box 52 to the consumables management server 30.

Consequently, the window information generation unit 30e receives the order instruction IO transmitted from the target user terminal 40 via the communication interface 30f (step S250). Since the order instruction IO is the instruction transmitted via the consumables purchase window 50 that is caused to display on the target user terminal 40 by window information UID, the order instruction IO may be represented as an order instruction for the consumables in accordance with the window information UID transmitted by the window information generation unit 30e. The window information generation unit 30e passes the order instruction IO transmitted from the target user terminal 40 to the order processing unit 30d.

The order processing unit 30d transmits a delivery request DR of consumables (the ink cartridge) specified by the order instruction IO to the sales channel 20 via the network NW in accordance with the channel identification information CID associated with the serial number DSN of the device 41 (step S260). That is, the order processing unit 30d determines channel identification information CID corresponding to the serial number DSN received together with the consumables information IR from the target user terminal 40 as described above by referring to correspondence of the serial number DSN and the channel identification information CID (stored in the storage unit 30b) managed by the identification information management unit 30a and transmits the delivery request DR to the sales channel 20 (the sales management server 22) indicated in the determined channel identification information CID. The sales channel 20 of the destination of the delivery request DR in step S260 is the sales channel 20 associated with the window information UID generated in step S220 (the sales channel 20 of the trade name “XXX-mart” according to the example of FIG. 8). The order processing unit 30d transmits the delivery request DR including the serial number DSN received together with the consumables information IR from the target user terminal 40 as described above and information indicating the consumables specified by the order instruction IO (for example, model number information or the like of a magenta ink cartridge when the order instruction IO specifies the magenta ink cartridge as the consumables).

Note that the control unit 31 performs steps S200 and S210 if the automatic consumables order process is performed, or skips step S220 to S250 and proceeds to step S260 if “Yes” is determined in step S210. In the automatic consumables order process, in step S260, the order processing unit 30d determines channel identification information CID corresponding to the serial number DSN received together with the consumables information IR from the target user terminal 40 as described above by referring to correspondence of the serial number DSN and the channel identification information CID (stored in the storage unit 30b) managed by the identification information management unit 30a and transmits the delivery request DR to the sales channel 20 (the sales management server 22) indicated in the determined channel identification information CID. Further, the serial number DSN received together with the consumables information IR from the target user terminal 40 as described above and the information indicating the consumables determined to be replaced in step S200 (consumables replacement determination) are included in the delivery request DR for transmission.

### 5. Process after Reception of Delivery Request

On the sales management server 22 side, the delivery processing unit 22c receives the delivery request DR transmitted from consumables management server 30. Next, the delivery processing unit 22c determines the address corresponding to the serial number DSN included in the received delivery request DR (delivery destination information) by referring to the serial number DSN of the device 41 included in the received delivery request DR and correspondence of the serial number DSN and the customer information CI (stored in the storage unit 22b) managed by the customer information management unit 22a. The delivery processing unit 22c then transmits the delivery request DR to the delivery-side terminal 23 together with the determined delivery destination information.

The delivery center 25 delivers the consumables in response to the delivery-side terminal 23 receiving the delivery request DR and the delivery destination information from the sales management server 22. That is, the delivery center 25 determines the consumables to be delivered in accordance with information indicating the consumables included in the delivery request DR and delivers the determined consumables to the address described in the delivery destination information using a predetermined logistic system. Consequently, the desired consumables are delivered to the user who has ordered the consumables through the consumables purchase window 50. Alternatively, for the user who has selected the automatic consumables order process, the consumables determined to be replaced in the consumables replacement determination is delivered.

As described above, according to the present embodiment, the consumables management server 30 comprises the storage unit 30b that stores identification information of the device 41 that utilizes consumables (the serial number DSN) and purchase source information (channel identification information CID) indicating a purchase source (the sales channel 20) from which the consumables are to be purchased in association with each other and the control unit 31 that, when receiving identification information of the device 41, generates window information UID used for purchasing consumables from the purchase source indicated in the purchase source information stored in the storage unit 30b in association with the identification information and transmits window information UID. That is, the consumables management server 30 generates window information UID dedicated for the purchase source associated with the identification information of the device 41 received from the outside (the user terminal 40) and transmits to the outside. The user terminal 40 that has received window information UID displays the consumables purchase window 50 dedicated for the purchase source in accordance with the window information UID and accepts an operation by the user. When receiving the order instruction IO of consumables in accordance with the transmitted window information UID (in response to the operation on the consumables purchase window 50), the control unit 31 transmits the delivery request DR of consumables to the purchase source associated with the window information UID. It is therefore possible to appropriately support the user of the device 41 to purchase consumables from the purchase source suitable for purchasing the consumables (the appropriate sales channel 20).

Further, according to the present embodiment, purchase source information stored in association with the identification information of the device 41 in the storage unit 30b indicates the purchase source of the device 41. Accordingly, window information UID can appropriately support the user to purchase consumables from the purchase source from which the user has purchased the device 41 (the sales channel 20). In other words, since the consumables are delivered from the purchase source from which the user has purchased the device 41, the profit of the purchase source is ensured.

Further, according to the present embodiment, the control unit 31 generates window information UID when receiving consumables information IR that indicates identification information and the consumption degree of the consumables and determining that the consumption degree exceeds a predetermined reference in accordance with the consumables information IR (steps S200 to S220). Therefore, consumables management server 30 can generate window information UID at an appropriate timing when the device 41 needs the replacement of consumables and thereby can support purchase of consumables.

Note that, the method of payment for the purchase of consumables in using the present service is not particularly limited in the present embodiment. For example, when the sales management server 22 receives the delivery request DR from the consumables management server 30, the sales channel 20 can perform a settlement for consumables corresponding to the delivery request DR by using the credit card number that is included in customer information CI registered in the sales management server 22.

### 6. Second Embodiment

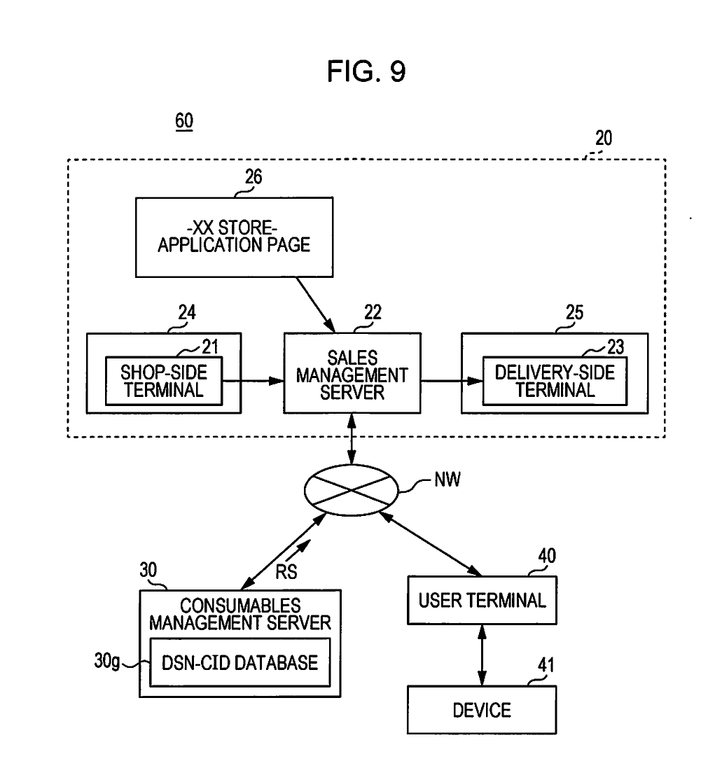

For convenience, the embodiment that has been described above may be referred to as the first embodiment. FIG. 9 schematically illustrates a system 60 according to the second embodiment. In the second embodiment, features of the system 60 which are different from the system 10 (the first embodiment) will be described.

According to FIG. 9, the consumables management server 30 has a DSN-CID database 30g (hereinafter, referred to as a database 30g). Alternatively, the consumables management server 30 is in a state of being able to refer to the database 30g. The database 30g is a database in which the serial numbers DSN of all the devices 41 that may use the present service and the channel identification information CID are associated. For example, when the device 41 is a printer, a manufacturer of the device 41 knows which serial number DSN of the device 41 has been shipped to which sales channel 20 when shipping (wholesaling) manufactured devices 41 to a plurality of sales channels 20. Accordingly, the database 30g describes such correspondence between the serial number DSN of the device 41 in a shipping stage and the shipping destination sales channel 20 (channel identification information CID).

FIG. 9 further illustrates a part of a website 26. The website 26 is a kind of websites is provided by the sales management server 22 on the Internet and is a site on which the user who has purchased the device 41 applies for use of the present service. The user who has purchased the device 41 at a shop 24 in the sales channel 20, for example, at any timing such as after returning home, may access the website 26 using the Internet and apply for use of the present service by entering various information (the serial number DSN of the purchased device 41 or customer information CI) on the website 26. The information input on the website 26 is acquired by the sales management server 22 providing the website 26.

In the first embodiment, the user applies for use of the present service to the shop 24 where the device 41 was purchased, and various information accompanying the application for the use (the serial number DSN of the device 41 or customer information CI) is transmitted to the sales management server 22 from the shop-side terminal 21. Therefore, in the first embodiment, it can be said that the sales channel 20 where the device 41 is purchased matches the sales channel 20 where the user who has purchased the device 41 applies for the use of the present service. In contrast, in the second embodiment, such a match is not necessarily guaranteed. As described above, there are a plurality of sales channels 20 for the devices 41. Further, a plurality of sales channels 20 are likely to open respective sites used for accepting applications for the use of the present service such as the website 26, for example.

Thus, for example, the user who has purchased a device 41 at the first sales channel 20 may use the Internet to access a website that is provided by the second sales channel different from the first sales channel 20 and apply for the use of the present service. In such a case, according to the flow in the first embodiment, even though the user has purchased the device 41 at the first sales channel 20, the subsequent delivery of consumables will be made from the second sales channel 20, and the profit of the first sales channel 20 may not be ensured.

To address such a problem, in the second embodiment, when receiving transmission of the serial number DSN of the device 41 and the channel identification information CID from the sales management server 22 of the sales channel 20 (See FIG. 2), the consumables management server 30 determines whether or not to register the serial number DSN and the channel identification information CID by referring to the database 30g. Specifically, when receiving the serial number DSN of the device 41 and the channel identification information CID from the sales management server 22, the identification information management unit 30a confirms whether or not the correspondence between the serial number DSN and the channel identification information CID has been registered in the database 30g.

When the serial number DSN and the channel identification information CID received from the sales management server 22 are stored in association with each other in the database 30g, the identification information management unit 30a stores the serial number DSN and the channel identification information CID in the storage unit 30b in association with each other. Then, as a response RS to the sales management server 22 that has transmitted the serial number DSN and the channel identification information CID, the identification information management unit 30a transmits a registration approval notification. This is because if the combination of the serial number DSN and the channel identification information CID received from the sales management server 22 is stored in the database 30g, it can be determined that the user has applied for the use of the present service to the purchase source of the device 41. The sales management server 22 that has received the registration approval notification as the response RS recognizes that the information which is transmitted by itself to the consumables management server 30 in response to the application for the use of the present service by the user has been registered in the consumables management server 30.

On the other hand, when the serial number DSN and the channel identification information CID received from the sales management server 22 are not stored in association with each other in the database 30g, the identification information management unit 30a does not store the serial number DSN and the channel identification information CID in association with each other in the storage unit 30b. Then, as a response RS to the sales management server 22 that has transmitted the serial number DSN and the channel identification information CID, the identification information management unit 30a transmits a registration disapproval notification. This is because if the combination of the serial number DSN and the channel identification information CID received from the sales management server 22 is not stored in the database 30g, it can be determined that the user has applied for the use of the present service to the sales channel 20 different from the purchase source of the device 41. The sales management server 22 that has received the registration disapproval notification as the response RS recognizes that the information which is transmitted by itself to the consumables management server 30 in response to the application for the use of the present service by the user has not been registered in the consumables management server 30.

In the sales management server 22 that has received the registration disapproval notification, the customer information management unit 22a deletes the information corresponding to the registration disapproval notification (the combination of the serial number DSN and the customer information CI) from the storage unit 22b. The sales management server 22 may notify the user who has applied for the use but was denied for registration of acceptance of the registration disapproval notification by way of some communication system such as electric mail. According to the second embodiment as described above, when the sales channel 20 by which the user has purchased the device 41 is different from the sales channel 20 by which the user applies for the use of the present service, registration of information to the consumables management server 30 is rejected, and the use of the present service is not available. As a result, the profit of the sales channel 20 by which the user has purchased the device 41 is more surely protected. In other words, sales efforts of respective sales channels 20 for the device 41 will be strongly linked to the sale of consumables of the respective sales channels 20.

### 7. Other Embodiments

The invention can further employ the following embodiments. A combination of a plurality of embodiments also forms the scope of the disclosure. The control unit 31 may generate price window information to display the price of the consumables designated at the consumables purchase window 50 displayed by window information UID and cause the communication unit (the communication interface 30f) to transmit the price window information. When the target user terminal 40 is in the state of displaying the consumables purchase window 50 and there is a predetermined operation on the consumables purchase window 50, such as an operation on the order button 55, the window information generation unit 30e detects the operation via the network NW and generates price window information.

Specifically, price window information is generated to display a web page of a price of an ink cartridge checked at the check box 52 on the consumables purchase window 50. The window information generation unit 30e inquires of the sales channel 20 associated with the window information UID the current sale price of the ink cartridge or refers to the sale price of the ink cartridge acquired in advance from the sales channel 20, for example, to generate price window information. The window information generation unit 30e then transmits the generated price window information to the target user terminal 40 via the communication interface 30f. The target user terminal 40 displays the web page that the sale price of the ink cartridge is described on the display unit in accordance with the received price window information. For example, when a predetermined confirmation operation on the web page describing the sale price is accepted, the target user terminal 40 may recognize that the order button 55 is duly operated and, at the same time, transmit the order instruction IO of the ink cartridge checked at the check box 52 to the consumables management server 30. According to such a configuration, it is possible to present the price of the consumables designated in the consumables purchase window 50 to the user and more appropriately support the user to make an order of consumables.

Consumables replacement determination may be performed by the user terminal 40 (the application 42). In this case, the application 42 acquires the threshold necessary for consumables replacement determination from the consumables management server 30 in advance. The application 42 then transmits consumables information IR including the remaining ink level together with the serial number DSN of the device 41 to the consumables management server 30 if the remaining ink level acquired from the device 41 is lower than the threshold. According to such a configuration, the consumables management server 30 may receive the consumables information IR and the serial number DSN from the user terminal 40 at an appropriate timing when the device 41 requires replacement of consumables and transmit window information UID to the user terminal 40 without performing the consumables replacement determination therein.

While it has been described assuming that the user terminal 40 and the device 41 are separate products, the device 41 may also function as the user terminal 40. That is, the device 41 itself may be a communication device in the invention. In this case, the application 42 (or a software implementing the same function as the application 42) or a browser is installed in the device 41. The device 41 then communicates with the consumables management server 30 or the like via the network NW and uses the resources of the device 41 to perform the processes that have been described as being executed by the user terminal 40. In this case, the device 41 may have the display unit, cause the display unit to display the consumables purchase window 50, and accept the operation made by the user on the consumables purchase window 50.

Further, it goes without saying that the consumables of the device 41 assumed in the present embodiment is not limited to an ink cartridge. For example, various consumables are conceivable, such as ink for replenishing an ink tank installed in a printer, a toner cartridge used in a laser printer, a waste ink/toner box used for temporarily storing waste ink and waste toner occurring in the printer, a replacement lamp for a projector, or the like.

The entire disclosure of Japanese Patent Application No. 2017-106402, filed May 30, 2017 is expressly incorporated by reference herein.

What is claimed is:

1. A server comprising:
a communication circuit that performs communication via a network;
a storage that stores association information in which identification information on a device that utilizes consumables is associated with purchase source information indicating a purchase source from which the consumables are to be purchased; and
a processor that, when the communication circuit receives identification information, causes the communication circuit to transmit window information used for purchasing the consumables from a purchase source indicated by the purchase source information associated with the received identification information in accordance with the association information.

2. The server according to claim 1,
wherein the communication circuit receives the identification information and consumables information that indicates a consumption degree of the consumables, and
wherein the processor generates the window information when the consumption degree is determined to exceed a predetermined reference in accordance with the consumables information.

3. The server according to claim 1, wherein, when the communication circuit receives an order instruction for the consumables in accordance with the transmitted window information, the processor causes the communication circuit to transmit a delivery request for the consumables to the purchase source associated with the window information.

4. The server according to claim 1, wherein the purchase source information stored in the storage in association with identification information of the device indicates a purchase source of the device.

5. The server according to claim 1, wherein the processor generates price window information to display a price of the consumables designated on a consumables purchase window that is displayed by the window information and causes the communication circuit to transmit the price window information.

6. A system comprising a communication device and a server that perform communication via a network,
wherein the server stores association information that associates identification information of a device that utilizes consumables with purchase source information that indicates the purchase source from which the consumables are to be purchased and, when receiving identification information from the communication device, transmits window information used for purchasing the consumables from a purchase source indicated by the purchase source information associated with the received identification information to the communication device in accordance with the association information, and
wherein the communication device causes a display to display consumables purchase window to purchase the consumables in accordance with the transmitted window information.
